(19) United States
(12) Patent Application Publication
(10) Pub. No.: US 2010/0260570 A1
(43) Pub. Date: Oct. 14, 2010

(54) Machine, Especially Machine Tool

(75) Inventor: Stefan Bogl, Sengenthal (DE)

Correspondence Address: DORITY & MANNING, P.A., POST OFFICE BOX 1449, GREENVILLE, SC, 29602-1449, US

(73) Assignee: MAX BOGL BAUUNTERNEHMUNG GMBH & CO. KG, Sengenthal (DE)

(21) Appl. No.: 12/678,550

(22) PCT Filed: Sep. 3, 2008
(86) PCT No.: PCT/EP08/61627

§ 371 Date: Mar. 17, 2010

(30) Foreign Application Priority Data
Sep. 17, 2007 (DE) 10 2007 044 253.1

(51) Int. Cl. B23Q 1/01

(52) U.S. Cl. 409/235

(57) ABSTRACT

The invention relates to a machine, especially a machine tool, e.g. a milling machine (1), comprising a machine frame (2) and machine modules that are arranged thereon. According to the invention, the machine frame (2) and/or at least one of the machine modifies is/are made at least in part of high-strength or ultra-high-strength concrete.

The invention refers to a machine, especially a machine tool such as a milling machine, for example, with a machine frame and machine modules arranged on it.

Machines such as machine tools in particular are available in the most varied executions, among them drilling machines, turning machines, grinding machines or even milling machines, but also other machines that are above all for machining tools. What all these machines have in common is that they must be sufficiently stable so the respective tool can be machined as accurately as possible. For this reason, these machines generally have frames and modules that—depending on the type of machine tool—can be made differently, from metal, especially steel. Metal has the advantage that it can be easily machined and is available in many different strengths but the disadvantage of metals is their relatively high raw material price.

Therefore, the task of this invention is to suggest a machine (especially a machine tool) that can be manufactured more economically and nonetheless still be sufficiently stable.

This task is solved by a machine according to the characteristics of claim 1.

According to the invention, it is suggested for the machine frame (which acts virtually as the basic body of the machine) and/or at least for one of the machine modules to be made at least partially of high-strength or ultra high-strength concrete. The utilization of this material has several advantages. The machine (for example, a machine tool) would have low temperature sensitivity with simultaneously high inner damping. Furthermore, the use of casings—advantageously of wood—allows the almost unlimited shaping of the machine frame and/or the machine modules that are just as good as the possibilities offered by metal shaping. Thus, complex components can now be made that heretofore could only be cast, welded or forged from metal. In this respect, high-strength concrete has the additional advantage that it tends to shrink less compared to cast steel. In addition, a possible shrinking can be almost fully anticipated by the corresponding heat treatment. Last but not least, the significantly lower price compared to metals must also be emphasized. Furthermore, it must be highlighted in this context that the invention is not just restricted to machines in the form of machine tools. Rather, all machines that require a particularly high strength can be made according to the invention's theory.

The machine therefore has advantageously at least one machine module in the form of a frame element, a machine table, a tool holder, a swiveling and/or rotating device and/or a guiding device. Whereas the machine table is primarily for mounting the tool to be machined, the swiveling and/or rotating device can fulfill the most varied tasks. Therefore, such devices can be utilized when rotating or swiveling a workpiece or other components (such as the tool holder itself), for example. Guiding devices always find a use when a machine frame has to be mounted in a moveable way relative to another machine module, the machine frame and/or the workpiece to be machined. In principle, all machine components that must have the corresponding stability can be made of high-strength concrete. It is therefore also conceivable to use high-strength concrete for the manufacturing of spindle sleeves to serve as an additional linear axis and the transfer of torque to the tool and/or workpiece. The machine module concept naturally encompasses the most varied braces, bearing elements or stiffening elements as well that can be present depending on the machine.

In this respect, it is especially advantageous if at least one machine module is glued at least partially onto the machine frame and/or another machine module because it won't be necessary to use most of the conventional connecting elements such as screws or pins. This especially lowers development costs, as the respective drilled holes for accepting the connecting elements do not have to be considered any longer. Naturally, conventional connecting elements can also be combined with the gluing techniques known to the specialist.

Likewise, it can also be advantageous for at least one machine module to be screwed at least partially onto the machine frame and/or another machine module, especially with insert nuts. Here, the most varied methods known to the specialist can be employed that advantageously guarantee a detachable attachment at any time.

In a particularly advantageous design, the machine has at least one guiding element on which the machine frame is moveably mounted. For example, the use of one or several guiding elements is advantageous if the workpiece is mounted in place and the machine—especially in the form of a machine tool (such as a milling or column milling machine, for example)—must be moved with respect to it for machining the workpiece. This is especially useful in large and/or heavy workpieces such as concrete supports. In this case, the machine has elements such as sliding guides (skids or rollers, for example) that act together with the guiding elements. In addition, a drive can be included (advantageously with an accompanying control unit) for moving the machine along the guiding element.

An advantage is that the guiding element comprises at least a base plate and/or a guiding rail, which in turn can rest on the base plate. As a result of this, the guiding element is subdivided into a holding surface and the guiding rail itself, which is in contact with the machine frame although both components can have different physical properties. It is therefore useful to manufacture the guiding rails from a particularly strong concrete or possibly from steel. However, the damping properties are potentially the most important factor with the base plate.

In this case, the guiding element is very advantageously mounted on a foundation to ensure that the machine will remain firmly in place so the workpieces to be worked on can be machined with extremely high precision.

It is an advantage for the foundation and/or guiding element to have anchorages too for attaching the foundation and guiding element and/or finely adjust the position of the guiding element and/or foundation. Especially if the anchorage has been designed so the fine adjustment mentioned above (accomplished through the corresponding screwing mechanisms, for example) is also made possible, the height and/or position of the guiding element (in particular with regard to the foundation) can be exactly adapted. Last but not least, this gives the machine a very high working precision.

Such anchorages can be pins, for example, but they can also be screw elements or threaded rods that, so to speak, ensure as much as possible the stable attachment of foundation with guiding element(s). In this case, the anchorages can also be detachably connected to the foundation and/or the guiding element and the respective wedge elements could be used for providing additional retention of the attachment.

In this context, it is especially advantageous if the anchorages are glued onto the foundation and/or guiding element and/or are cast, preferably with cement mortar. Such an attachment results in a stable and nonetheless easily achieved fixation of the anchorage. Naturally, the guiding element can also be directly glued or cast onto the foundation without using the respective anchorages for achieving an especially simple design.

It is likewise advantageous for the guiding element and/or foundation to be made of high-strength concrete because these structural components are also generally exposed to high stresses that take the form of high pressure loads in particular. The easy machining of concrete allows the very precise manufacturing of the structural parts mentioned above, something especially advantageous when designing the guiding elements because their precision has a direct effect in the machining precision of the workpiece in question.

It is also advantageous for the machine frame, at least one of the machine modules, the guiding element and/or the foundation to be machined especially through grinding and/or milling. Such machining methods ensure very high-precision structural components down to the level of a few pm. In this case, it is useful to allow the respective structural components to be hardened so subsequent concrete shrinkage can be ruled out.

In an especially advantageous machine design, the concrete has an elasticity module higher than 50,000 but especially one exceeding 60,000 N/mm² to ensure that the concrete will be able to resist extremely high loads without undergoing large deformations. This is especially very advantageous when the machine must transfer large forces to a workpiece that needs to be machined but high machining precision must also be ensured. The high strength of the concrete is also absolutely necessary if the machine has a certain size of its own that results in the corresponding high forces acting by themselves on the machine. Thus, the respective milling machines can be used when machining Transrapid supports, which are generally more than 1 meter high.

It is also advantageous for the high-strength concrete to be high-strength light concrete because then the weight of a machine manufactured from it can be significantly reduced but still be sufficiently stable. This is especially advantageous with moveable tool modules such as the tool holder or corresponding swiveling or rotating devices.

A further advantage is low-shrinkage concrete because this ensures that the machine's structural components made from it will retain their shape after their completion. In addition, the time spent between casting the structural component and subsequent machining is reduced.

It is an advantage for the concrete to be also or alternatively subject to heat treatment. This process significantly accelerates the hardening of the concrete.

Concrete additives confer another advantage to the concrete. Additives such as plasticizers, silica or others known to the specialist make it possible to influence the quality of the concrete depending on the type of additive. Likewise, the addition of fibers has proven effective because their use significantly improves the concrete's stability.

An additional advantage results from concrete pre-stressing, which is particularly useful with bent-loaded structural components and can be carried out either by direct connection or through external pre-stress.

The invention will now be explained with the help of two figures, which show:

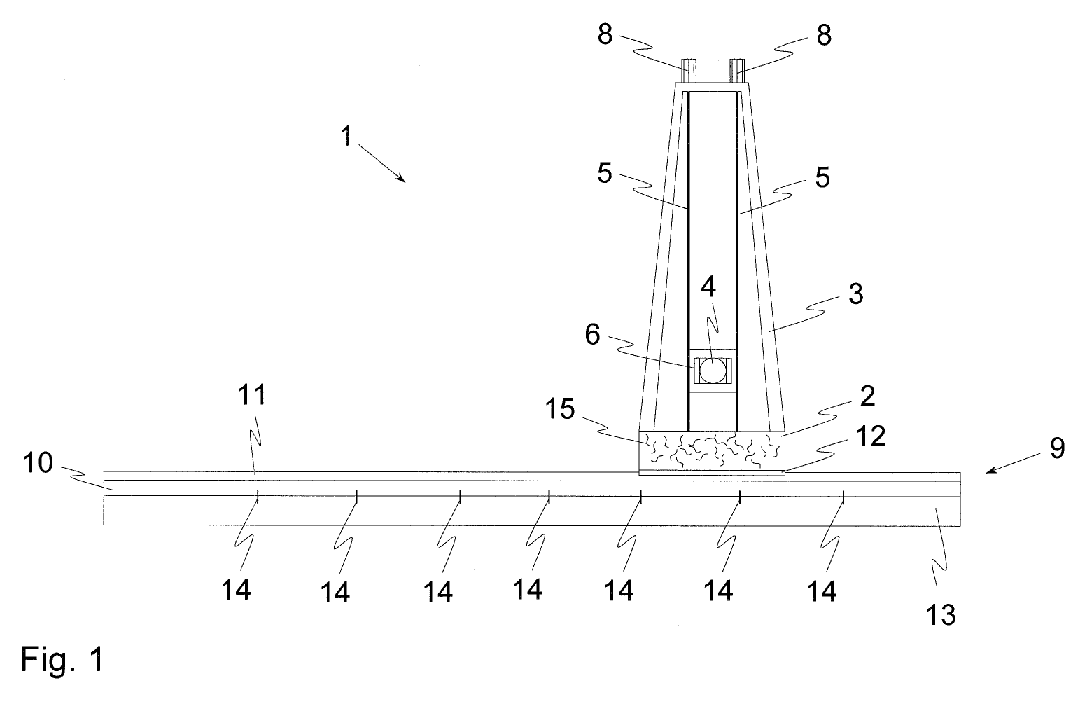

FIG. 1 a diagrammatic lateral view of a machine according to the invention in the form of a machine tool, and

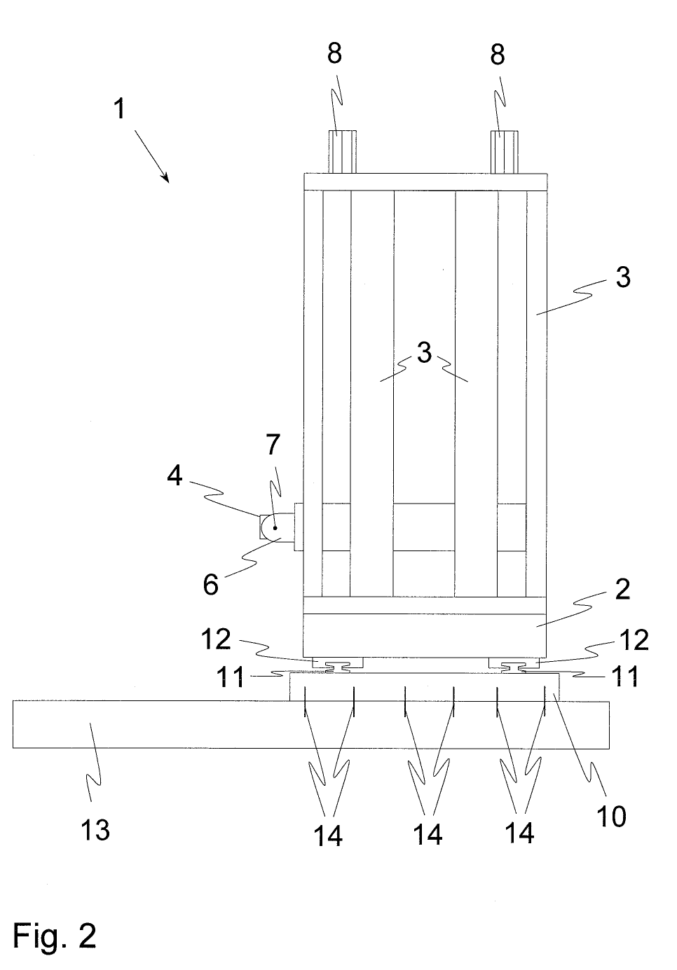

FIG. 2 a diagrammatic front view of a machine according to the invention in the form of a machine tool.

FIGS. 1 and 2 shows a diagrammatic lateral and front view of a machine according to the invention. As an example, a machine tool in the form of a milling machine 1 was chosen, although naturally other machines such as turning, drilling or even grinding machines can be designed according to theory and the patent claims. Furthermore, the machine concept within the framework of the invention also includes numerous other machines made especially for machining workpieces or that must be made from a high-strength material for other reasons.

The milling machine 1 shown here has a machine frame 2 that virtually serves as basic body for receiving additional machine modules, as described below. Thus, the machine frame 2 has a frame element 3 on which a tool holder 4 is supported so it can be displaced vertically with the help of guiding devices 5. The tool holder 4 is equipped with a mounted swiveling or rotating device 6 so it can be rotated around a horizontal axis 7 (see FIG. 1) but also around a longitudinal axis extending along the drawing plane of FIG. 1. Additionally, the tool holder 4 has been mounted so it can also be horizontally displaced along the longitudinal axis. As a result of this, a tool not shown (such as a milling head, for example) can be aligned in all three spatial axes according to the desired shape of the tool that must be machined. Here, the vertical movement of the tool holder 4 within the guiding devices 5 can take place with a spindle or chain drive, to which the corresponding controllable drive units 8 have been assigned. Needless to say, the tool holder 4 also has a drive (not shown) for actually moving the tool.

Furthermore, the machine frame 2 has been movably attached to a guiding element 9 (for better clarity, merely provided with reference marks in FIG. 1) that in the embodiment shown consists of a base plate 10 having two guiding rails 11 that run parallel to each other. These are, in turn, encompassed by the corresponding skids 12 of the base frame to ensure its secure guidance along the guiding element 9. Naturally, rollers or other gliding elements can be used instead of skids 12.

To prevent a sinking of the tool machine into the sub-floor and ensure the needed stability of the machine tool, the latter also has a foundation 13 attached to the guiding element 9. The base plate 10 of the guiding element 9 can be attached to the foundation 13 with the most varied gluing techniques but also conventionally with screws or plugs. In the embodiment shown, the attachment is done with anchorages in the form of pins and/or threaded rods 14 that are accepted by the corresponding drill holes in the foundation 13 and base plate 10. The threaded rods 14 themselves are in turn glued to the drill holes or accepted by the existing threading elements, therefore creating an especially simple but nonetheless stable connection between base plate 10 and foundation 13. Naturally, the base element can also be dispensed with, although in this case the guiding rails 11 are directly attached to the foundation 13 using one of the methods shown.

In accordance with the invention, the machine frame 2 and/or individual machine modules (such as the frame element 3, the guiding device 5, the base plate 10 of the guiding element 9, the guiding element 9 itself, the tool holder 4 and/or the foundation 13) are made at least partially of high-strength concrete whose elasticity module in an advantageous design amounts to more than 50,000 N/mm² and in an especially advantageous embodiment of the invention can reach more than 60,000 N/mm².

Likewise, high-strength concrete can also be used for significantly reducing the weight of the machine tool. Since most machine tools are made for machining the respective workpieces with extremely high precision, it is also advantageous to use low-shrinkage concrete to ensure the sufficient form stability of the corresponding structural parts.

So the stability or other properties of the concrete can be positively influenced, it is also advantageous to add the respective admixtures to it, such as plasticizers or silica. The addition of fibers 15, as shown in the example of the machine frame 2 in FIG. 1, contributes to increase the stability of the respective structural part.

The additives mentioned above are generally added when the concrete is still liquid. Finally, it is then cast into the corresponding casing and after hardening, the desired part is given its final form by machining it through grinding or milling. Current casing and machining methods can reach precisions of a few μm. In this case, additional or alternative drilling devices can be used for manufacturing the respective holders for the threaded rods, for example.

This invention was explained more thoroughly with the help of embodiments. Variations of the invention are certainly possible within the scope of the patent claims. In this case, all characteristics listed in the description and in the figure descriptions can be expressly realized in any combination with one another as long as it seems useful and possible.

1. Machine, especially a machine tool such as a milling machine (1) with a machine frame (2) and machine modules arranged on it, characterized in that the machine frame (2) and/or at least one of the machine modules is at least partially made of high-strength or ultra high-strength concrete.

2-18. (canceled)
